(19) United States
(12) Patent Application Publication
(10) Pub. No.: US 2007/0166197 A1
(43) Pub. Date: Jul. 19, 2007

(54) Means for covering microscopic specimens

(76) Inventors: Guenter Hauke, Muehltal (DE); Daniela Grabis, Schwetzingen (DE); Andreas Beirau, Darmstadt (DE); Heinz Allmann, Modautal (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/591,534

(22) PCT Filed: Feb. 1, 2005
(86) PCT No.: PCT/EP05/00982

§ 371 Date: Sep. 1, 2006

(30) Foreign Application Priority Data
Mar. 4, 2004 (EP) 04005103.9

(51) Int. Cl. B01L 3/00

(52) U.S. Cl. 422/99

(57) ABSTRACT

The invention relates to cover slips coated with covering medium for covering specimens and to machine processes for the production thereof. The cover slips according to the invention greatly simplify the covering of specimens since firstly there is no need to handle the tacky covering medium and secondly the specimens are permanently covered after just a few minutes and can be investigated under a microscope even using immersion objectives. The covering medium layer thicknesses and layer-thickness tolerances according to the invention produce stable and durable covering.

The invention relates to cover slips coated with covering medium, to processes for the production thereof, and to the use thereof in the manual and automatic covering of microscopic specimens.

The microscopic investigation of specimens in transmitted light is based on the refraction of light at very thin objects. To this end, the specimens are firstly mounted on a specimen slide, treated with reagents, such as staining reagents or dehydrating agents, and subsequently encased in a glass-like resin. This is carried out by embedding or infiltration of resins in the samples. These resins, also known as covering media, penetrate the thin section of the material under investigation and bond, ideally without phase refraction, to the specimen slide beneath the material and the cover slip above the material. In this way, a specimen embedded in a glass phase is obtained which is highly suitable for investigation under a transmitted-light microscope and at the same time is preserved.

The preferred material used for specimen slides and cover slips is generally glass. However, it is also possible, for example, to use a plastic film or cover slips made of plastic instead of a glass cover slip for covering the specimens. However, in contrast to glass, these materials have the disadvantage that they are not completely impermeable to solvents. The covered specimens age more quickly and the cover film can become detached.

The covering of specimens can be carried out in hydrophobic or hydrophilic covering media.

For covering in hydrophobic media, the specimen, after it has been mounted on the specimen slide and stained, must firstly be dehydrated. To this end, it is introduced via a rising alcohol series culminating in xylene or a xylene substitute. The specimen slide is subsequently provided with the hydrophobic covering medium, and the cover slip is placed on top in such a way that air bubbles are not formed in the specimen. After the covering medium has cured, the specimen is encased in an air-tight manner in a glass-like environment and can be investigated under a transmitted-light microscope.

For covering in hydrophilic covering media, the sample does not have to be dehydrated, but instead can be provided immediately with the covering medium. After covering with the cover slip and curing of the covering medium, the specimen is encased in an air-tight manner in a glass-like environment, as in the case of the use of a hydrophobic covering medium, and can be investigated under a transmitted-light microscope.

The covering of specimens is a very complex and time-consuming step. If the covering medium is applied manually to the specimen slide, it must be ensured that a constant amount is always applied, since otherwise the medium escapes at the side and conglutinates, or alternatively the covering is incomplete. Even on use of automatic covering machines, defects frequently occur since escaping covering medium clogs up the machine. If the covered specimens are stacked too quickly after covering or are stored close together, they can also stick to one another or to their environment.

Furthermore, the covering medium requires drying times of at least 30 minutes, in the case of hydrophilic media even more than 45 minutes, for curing. In this way, long waiting times have to be accepted before the embedded specimen can be investigated under the microscope. This applies, in particular, to investigations using immersion objectives. The large time requirement is in addition a major disadvantage in particular in rapid sections, which, for example, have to be removed during an operation and investigated immediately.

U.S. Pat. No. 3,498,860 and EP 1242800 disclose the use of cover slips which have already been coated in advance with covering medium or adhesive. The advantage of this process is that the cover slip can be coated in advance with the covering medium, dried and stored until use. There is no need to work with liquid covering media during the covering. The drying times are also greatly shortened.

Nevertheless, the process disclosed in U.S. Pat. No. 3,498,860 and EP 1242800 did not find use in practice since the coated cover slips only exhibited moderate adhesive properties and frequently became detached again after a short time.

The object of the present invention was therefore to provide cover slips coated with covering medium which do not have the disadvantages of the prior art.

It has been found that cover slips coated with covering medium which have very good adhesive properties and long lives can be produced if the layer of covering medium is between 0.05 and 0.8 mm and the layer-thickness tolerance is not more than ±0.1 mm, preferably not more than ±0.05 mm. Coatings having these properties cannot be produced reliably by manual methods. However, it has been found that machine processes enable the production of the cover slips with the desired coating.

The invention therefore relates to a means for covering specimens which essentially consists of a cover slip and a layer of a covering medium applied thereto, characterised in that the layer thickness of the covering medium is between 0.05 and 0.8 mm and the layer-thickness tolerance is not more than ±0.1 mm.

In a preferred embodiment, the layer-thickness tolerance is not more than ±0.05 mm.

In a preferred embodiment, the layer thickness of the covering medium is about 0.2 mm.

In a preferred embodiment, the cover slip is made of glass.

In a preferred embodiment, the solids content of the covering medium in the dried state on an area of 24×50 mm is 150-300 mg.

The present invention additionally relates to a process for the production of cover slips coated with covering medium, characterised in that the covering medium is applied to the cover slip by machine by means of one or more dispensing needles, by means of printing processes, coating by a liquid curtain, application through a slot nozzle, distribution by means of a doctor blade or by means of spin coating with a layer thickness of between 0.05 and 0.8 mm and a layer-thickness tolerance of not more than ±0.1 mm.

In a preferred embodiment, the covering medium is applied by means of one or more dispensing needles.

In another preferred embodiment, the covering medium is applied by means of screen printing.

The invention also relates to the use of a cover slip according to the invention coated with covering medium for the manual or automatic covering of specimens.

In accordance with the invention, covering of specimens means the provision of a specimen slide on which a mounted, optionally stained specimen wetted with intermedium is located, and a cover slip coated in accordance with the invention and the subsequent covering of the specimen slide with the cover slip. The term intermedium is applied in the case of covering with hydrophobic covering media to the final solvent of the dehydration series or the staining, i.e. typically xylene or xylene substitutes, in the case of covering with hydrophilic covering media typically water. The specimens can be stored in these solvents over an extended period until covering.

The cover slip according to the invention greatly simplifies the covering of specimens. Whereas covering in accordance with the prior art requires the bringing together of three components, i.e. the specimen slide with the mounted specimen, the liquid covering medium and the cover slip, the process is reduced in accordance with the invention to two easily handled components, i.e. the specimen slide with the mounted specimen moistened with intermedium, and the coated cover slip.

In accordance with the invention, the term cover slip encompasses all cover slips which are known and suitable for the purpose, such as, for example, cover slips made of glass or plastic or also films. Preference is given in accordance with the invention to cover slips made of glass. Depending on their size, these are preferably provided on one side with a defined amount of the liquid covering medium.

In a preferred embodiment of the present invention, one side one side of a cover slip is provided in its entirety with a layer of a covering medium. However, it is also possible for the layer not to cover the cover slip in its entirety, but instead to leave the edge regions free. It is important, in particular, that the cover slip is covered with the covering-medium layer according to the invention at the points where the specimen to be investigated under a microscope is located. The layer of covering medium here must be larger than the area of the specimen by a sufficient amount that it projects beyond the specimen on all sides and thus a strong bond arises to the specimen slide on which the specimen is located.

The covering medium employed for the coating of cover slips can be all covering media typically used for covering in accordance with the prior art. The coating can be carried out both with hydrophobic and also with hydrophilic covering media. These are, for example, covering media based on organic polymers, such as Canada balsam, acrylate resins, for example polymethacrylate, polystyrene, polyvinylpyrrolidone, polyvinyl alcohol or glycerin gelatine. Covering media of this type typically comprise solvents, such as water, xylene or xylene substitutes, such as toluene, or other aromatic or aliphatic hydrocarbons, and also other additives known to the person skilled in the art. Further examples of covering media are found in “Romeis-Mikroskopische Technik” [Romeis-Microscopic Techniques], Urban & Schwarzenberg, 17th edition, 1989, page 296-297.

It has been found that the solids content of the covering media for the coating of the cover slips should be about 40% or more. However, this value should only be regarded as a guide value, but not as an absolute value. Depending on the respective solid component, the surface tension and the viscosity of the covering medium, this value may change. The person skilled in the area of covering is capable of assessing, by means of this guide value, after a few coating and covering tests, what solids content and what volume of covering medium per mm² of cover slip is appropriate for the particular covering medium.

The viscosity of the commercially available covering media can be increased before their use by evaporation of some of the solvent, so that the solids content increases. Covering media having a viscosity of between 2000 and 4000 mPas have proven particularly suitable. The use of covering media having a viscosity of about 3000 mPas is particularly advantageous. Processing of higher-viscosity media is not really possible at the layer thickness and layer-thickness tolerance to be achieved.

The solids content of the covering medium in the dried state should be between 150 and 300 mg on an area of 24×50 mm. About 200 mg are preferably applied to an area of 24×50 mm. If the solids content is higher, there is a risk that the layer thickness is so great that the solvent does not penetrate the layer or does not penetrate the layer sufficiently quickly during covering, and bonding of specimen slide and cover slip then does not occur.

If too little is applied, the polymer mass is insufficient and the functionality is not ensured.

It has been found that a parameter of the coated cover slips which is critical for stable and durable covering is, in particular, the layer thickness of the covering medium and the layer-thickness tolerance. If the layer thickness varies over a tolerance of ±0.1 mm, the cover slip frequently becomes detached from the specimen at some points after only a short time. The specimen consequently ages prematurely and can no longer be investigated microscopically. An optimum storage stability and durability was evident in the case of coatings having a thickness of between 0.05 and 0.8 mm, preferably between 0.1 and 0.4 mm, and a layer-thickness tolerance of not more than ±0.1 mm, preferably not more than ±0.05 mm, particularly preferably not more than ±0.02 mm. A coating of this type can only be applied with difficulty and unreliably by hand. However, it has been found that various machine processes are highly suitable for uniform application of the covering medium to the cover slips:

Application by Means of Dispensing Needle(s)

Application by means of one or more dispensing needles is particularly preferred. This process enables full-area and also part-area coating of the materials to be coated. The covering medium is placed in a container and applied to the cover slip via one or more dispensing needles, for example with the aid of a dispensing pump, compressed air, liquid pressure or by means of a piston. The coating is carried out by moving the dispensing needle and/or the cover slip or the container with the cover slip in the x and y direction. The corresponding homogeneous surface and layer thickness can be controlled via the speed of movement of the needle or cover slip in the x/y direction and/or via the amount throughput from the needles.

The advantage of this process is that the covering medium can be adjusted precisely in advance with respect to the viscosity and remains in a closed system until discharge (no change in viscosity during the coating process). The diameter of the dispensing needle is typically between 0.25 and 7.5 mm, preferably about 0.8 mm. It must be ensured that the separation between needle and cover slip must take place with very narrow tolerances—corresponding to the tolerances of the layer thickness. The separation of the dispensing needle from the cover slip should correspond to the desired layer thickness of the covering medium. The coating can be optimised for each covering medium through the speed of the dispensing needle, the separations of the individual coating lines, the volume flow of the covering medium and the viscosity of the covering medium.

If necessary, the needles and/or the covering medium can be warmed.

Printing Processes

For the coating of the cover slips, films and plates, printing processes are also suitable. The most important for this purpose are:
pad printing
offset printing
gravure printing
screen printing
ink-jet

Of these, a process which has proven particularly suitable is the screen-printing process.

It is possible here to work with high-viscosity covering media and thus to apply defined layer thicknesses. In addition, the screen can be designed in such a way that only the desired areas are coated. In order to ensure long print runs and good utilisation of the large-format machines, the cover slips must be placed in a carrier. This can accommodate a large number of platelets. It must be designed in such a way that cavities are provided into which the cover slips fit accurately so that a flat surface for the printing is provided. Since high forces occur during printing, the cover slips are preferably fixed with vacuum support.

The covering composition is then placed in the screen and the printing operation is subsequently started.

A filling doctor blade typically distributes the medium over the entire screen. The printing doctor blade subsequently moves over the latter. It forces the filled screen, which has a separation of a few millimetres from the cover slips, onto the latter. This prints the covering composition onto the cover slips.

The layer thickness depends exclusively on the screen used. The open mesh width and the filament diameter of the screen must be matched here to the respective covering medium, in particular its viscosity. In general, suitable screens are those having mesh widths of between 300 and 1500 μm, preferably between 500 and 1000 μm, and filament diameters of between 100 and 500 μm. For example, in the case of a covering medium having a viscosity of 2900 mPas, a moist layer thickness of 200 μm was achieved using a screen having a mesh width of 688 μm and a filament diameter of 140 μm. Drying then causes the layer thickness to reduce somewhat. It is frequently advantageous, in particular in the case of covering media of relatively low viscosity, to carry out not only one screen-printing coating, but instead two or more, for example using a carousel screen-printing process.

After the printing, the carrier containing the cover slips is removed and a new operation can be prepared.

Coating by a Liquid Curtain

The cover slips are pushed under a liquid curtain.

The layer thickness is determined by the speed of the slips and the volume flow of the covering medium.

For this process, the covering medium must be very highly diluted in order to ensure uniform flow. It may consequently be advantageous to carry out a plurality of coating passes.

The advantages of this process consist in the particularly uniform surface than can be achieved in this way.

Application Through a Slot Nozzle

In this process, the covering medium is forced by means of pressure through a slot nozzle which has precisely the width of the cover slips. By moving the nozzle, the entire surface is scanned and the medium is thus applied to the slip.

The nozzle may be designed either in such a way that the medium is applied from the nozzle directly to the slip or in such a way that the medium, after hitting the glass surface, is spread thereon by a device.

Spot Application of the Covering Medium and Distribution Using a Slide (Application by Doctor Blade)

The covering medium is, analogously to the manual process, applied to the cover slip at one point. It is subsequently distributed using a slide, a so-called doctor blade. This may be a spiral doctor blade, which is moved directly on the glass surface, or a plate, which is moved at the separation to which the desired layer thickness corresponds.

In this process, an accurate layer thickness can be achieved well. However, a little covering medium is always forced away at the side. A carrier, into which the cover slips are placed, is therefore necessary for the coating. This also has to be cleaned after each coating pass. In addition, the platelets must always be separated from the carrier for drying since they can no longer be detached after curing of the medium.

Spin Coating

In this process, the cover slip to be coated rotates. The covering medium is applied in drop form and distributed by the centrifugal force.

Since some medium always leaves the surface of the glass, constant cleaning of the spin-coating machine is necessary here since otherwise soiling and sticking of the glasses cannot be excluded.

In general, the application of the covering medium is followed in each of the processes mentioned by a drying step. If the coated cover slips are to be employed immediately, a drying time of 1 to 5 minutes is sufficient, preferably at slightly elevated temperature in a drying cabinet. Excessive temperatures, i.e. temperatures above 60-80° C., are unsuitable for many covering media since the polymer is attacked and cracks may occur in the coating.

If the cover slips are to be stored and for this purpose possibly also stacked immediately on top of one another, longer drying times of up to 24 hours are then advantageous. 2 hours at 60° C. in a drying cabinet, for example, have proven highly suitable.

For the covering, the coated cover slip is placed using a known technique with the coated side on a specimen slide which is still moist by intermedium. Due to the coating with the covering medium, the cover slip and specimen slide bond within a few seconds and cure. The specimen is typically completely cured after only 3 minutes, usually even after less than one minute, and can then be investigated under a microscope, for example using immersion objectives.

The simple handling makes the coated cover slip according to the invention suitable both for manual and also for automatic covering of specimens. Since it is not necessary to use a liquid covering medium for the covering, there is no risk of sticking. The specimens fixed on the specimen slides are preferably removed from the final solution (intermedium), i.e., for example, water or xylene or xylene substitutes, directly after staining and optionally after dehydration and covered in the still-moist state. If the specimens are already virtually dry, they should be moistened again with a little intermedium.

A further parameter which should be noted is the type and thickness of the specimens. The cover slip according to the invention is suitable for the covering of specimens from, for example, histology and cytology, as are typically also covered in accordance with the prior art. Thus, the cover slips according to the invention are particularly suitable for the covering of specimens having a thickness of up to 15 μm. Depending on the thickness of the coating of the cover slip and the nature of the covering medium, thicker specimens may also be covered.

Besides manual covering, the coated cover slips and the process according to the invention can also be used for automatic covering using automatic covering machines. Automatic covering machines which wet the specimen slides with a defined amount of covering medium in accordance with the prior art and subsequently place the cover slip in position are commercially available. The covering process according to the invention can be carried out using both automatic covering machines in accordance with the prior art, whose function is slightly modified, and also automatic covering machines designed for the process according to the invention. Conventional automatic covering machines have a dispensing pump in order to apply liquid covering medium to the specimen slides. This is not necessary in the process according to the invention. Accordingly, this step can be omitted on use of automatic covering machines for the process according to the invention. A further possibility consists in applying a little intermedium (water, xylene, etc.) to the specimen slides via this dispensing device instead of the covering medium. Since the specimen slides should still be moist with the specimens for the process according to the invention, specimens which are already slightly dried again after staining or dehydration could be re-moistened by a small amount of intermedium. The specimen is subsequently covered with the cover slip according to the invention.

In another embodiment of an automatic covering machine, which is particularly suitable for the process according to the invention, the specimen slides with the specimens are stored in a container filled with solvent (intermedium). The specimen slides are only transported out of the solvent container for covering and covered directly with the coated cover slip. The application of covering medium or further amounts of solvent is not necessary here.

Due to the use of the cover slip according to the invention, the automatic covering machines are treated significantly more gently than with conventional processes since it is not possible for tacky covering medium to enter the machine. Precisely as in the case of manual covering, the specimens can be investigated under a microscope after only a short time.

The cover slips according to the invention and the process according to the invention for the production of these cover slips thus offers the possibility of covering specimens quickly and simply. Manual handling of tacky covering compositions is superfluous. A durable covering is produced by the covering medium layer thickness and layer-thickness tolerance according to the invention. The covered specimens can be stored over a long period without the cover slip becoming detached.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application EP 04005103.9, filed on 04.03.2004, is incorporated into this application by way of reference.

### EXAMPLES

1. Coating by Means of Screen Printing

A screen having an open mesh width of 688 μm and a filament diameter of 140 μm is stretched onto a 700*500 mm frame and mounted on an automatic flat-bed screen-printing machine.

On a support, 6*7 rows of 25*50 mm cover slips are positioned on a carrier by means of vacuum.

The covering medium having a viscosity of 2900 mPas is applied to the screen, the screen is lowered over the cover slips, and the covering medium is then forced through the screen onto the cover slips with the aid of a doctor blade.

Immediately thereafter, the screen is raised again. The cover slips are subsequently removed for drying.

2. Coating by Means of Dispensing Needles

The cover slips (25×50 mm) are positioned on a vacuum stage with the aid of a device.

The diameter of the dispensing needles is from 0.8 mm. The covering medium used is Entellan® having a viscosity of 2900 mPas.

A syringe with dispensing needle is filled and sealed with a piston.

The separation between dispensing needle and cover slip should correspond to the layer thickness to be applied (here: 0.2 mm)

The dispensing needle is positioned above a cover slip by means of a dispensing robot. The syringe plunger is then loaded with about 2 bar and the needle is moved at a speed of 60-100 mm/min.

Individual “covering-medium folds” as Z-form are applied.

By means of this procedure, the cover slips are coated individually.

1. Means for covering specimens which essentially consists of a cover slip and a layer of a covering medium applied thereto, characterised in that the layer thickness of the covering medium is between 0.05 and 0.8 mm and the layer-thickness tolerance is not more than ±0.1 mm.

2. Means according to claim 1, characterised in that the layer-thickness tolerance is not more than ±0.05 mm.

3. Means according to claim 1, characterised in that the layer thickness of the covering medium is about 0.2 mm.

4. Means according to claim 1, characterised in that the cover slip is made of glass.

5. Means according to claim 1, characterised in that the solids content of the covering medium in the dried state on an area of 24×50 mm is 150-300 mg.

6. Process for the production of cover slips coated with covering medium, characterised in that the covering medium is applied to the cover slip by machine by means of one or more dispensing needles, by means of printing processes, coating by a liquid curtain, application through a slot nozzle, distribution by means of a doctor blade or by means of spin coating with a layer thickness of between 0.05 and 0.8 mm and a layer-thickness tolerance of not more than ±0.1 mm.

7. Process according to claim 6, characterised in that the covering medium is applied by means of one or more dispensing needles.

8. Process according to claim 6, characterised in that the covering medium is applied by means of screen printing.

9. Use of a means for covering specimens according to claim 1 for manual or automatic covering of specimens.
